(19) United States
(12) Patent Application Publication
(10) Pub. No.: US 2008/0318761 A1
(43) Pub. Date: Dec. 25, 2008

(54) Process for the Preparation of Mixed Oxides by Means of Spray Pyrolysis

(76) Inventors: Guenter Riedel, Kelkheim (DE); Matthias Koch, Wiesbaden (DE); Stefan Ambrosius, Berlstedt (DE); Steffen Frank, Wernigerode (DE); Tarek Khalil, Weimar (DE); Lars Leidolph, Erfurt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/814,237

(22) PCT Filed: Dec. 24, 2005
(86) PCT No.: PCT/EP2005/014028

§ 371 Date: Jul. 18, 2008

(30) Foreign Application Priority Data
Jan. 19, 2005 (DE) 102005002659.1

(51) Int. Cl. C04B 35/462; C09K 11/64; C09K 11/80; C09K 3/00; C04B 35/44

(52) U.S. Cl. 501/134; 252/301.4 R; 252/301.4 F; 252/182.35; 252/182.33

(57) ABSTRACT

The present invention relates to a novel process for the preparation of compact, spherical mixed oxide powders having an average particle size of <10 μm by spray pyrolysis, and to the use thereof as phosphor, as base material for phosphors or as starting material for ceramic production or for the preparation of high-density, high-strength and optionally transparent bulk material by means of hot-pressing technology.

The present invention relates to a novel process for the preparation of compact, spherical mixed oxide powders having an average particle size of <10 μm by spray pyrolysis, and to the use thereof.

Mixed oxide powders having particle sizes in the nanometre or submicron range are prepared essentially by means of the following processes:

mixing, drying and subsequent thermal decomposition of oxides, carbonates nitrates, acetates, chlorides or other salts (solid-state reaction); co-precipitation and subsequent drying and calcination; sol-gel technique; hydrolysis of alkoxides; plasma spraying processes; spray pyrolysis of aqueous and organic salt solutions.

Spray pyrolysis (SP) is one of the aerosol processes, which are characterised by spraying of solutions, suspensions or dispersions into a reaction space (reactor) which is heated in various ways and the formation and deposition of solid particles. In contrast to spray drying with hot-gas temperatures <300° C., in addition to evaporation of the solvent, thermal decomposition of the starting materials used (for example salts) and new formation of substances (for example oxides, mixed oxides) additionally take place during spray pyrolysis as a high-temperature process.

Due to differences in heat generation and transfer, the supply of energy and feed product, the manner of aerosol generation and the manner of particle deposition, there is a multiplicity of process variants, which are also characterised by different reactor designs:
hot-wall reactor—externally electrically heated tube, optionally with separately controllable heating zones; low energy input at the spray-in point;
flame pyrolysis reactor—energy and hot-gas generation by means of reaction of fuel gas (for example hydrogen) with oxygen or air; spraying directly into the flame or into the hot combustion gases in the region close to the flame; very high energy input at the spray-in point
hot-gas reactor—hot-gas generation by
   electrical gas heater (introduction of the aerosol into the carrier gas; variable, but usually limited (low) energy input at the spray-in point)
   flameless, pulsating combustion of hydrogen or natural gas using air in a pulsation reactor; energy input which can be controlled in a broad range at the spray-in point; pulsating gas flow with a high degree of turbulence (see International Patent Application WO 02/072471 by Merck Patent GmbH)

Spray pyrolysis processes prove to be particularly effective if the desired powder properties, such as particle size, particle size distribution, particle morphology and content of crystallographic phases, are successfully achieved without further post-treatment.

Regarding this situation, the following process variants of the literature are described:

Kuntz et al. (DE 3916643 A1) claim a process for the preparation of oxidic ceramic powders by spray pyrolysis of metal nitrate solutions in the presence of organic substances functioning as fuel, such as, for example, ethanol, isopropanol, tartaric acid or elemental carbon. The preparation of zinc oxide with addition of Bi, Mn, Cr, Co, Sb₂O₃ and Bi₂Ti₂O₇ powder is described.

Hilarius (DE 4320836 A1) describes a process for the preparation of a metal oxide powder which comprises the doping elements for a ceramic varistor based on doped zinc oxide, where the metal oxide powder has crystalline phases with a spinel and/or pyrochlore structure, characterised in that firstly compounds of the requisite doping elements are mixed in the proposed stoichiometric ratio to give a joint aqueous homogeneously disperse solution, and this is then subjected to spray pyrolysis.

DE 4307 333 A1 (Butzke) proposes firstly dispersing and emulsifying the mixed nitrate solutions with the elements Zn, Sb, Bi, Co, Mn, Cr in an organic phase before the spray pyrolysis in order to produce finely divided, spherical metal oxide powders.

The Journal of the Korean Ceramic Soc. 27 (1990), No. 8; pp. 955-964 reports on the preparation of Al₂O₃/ZrO₂ composite powders by means of an emulsion spray pyrolysis method, where the starting materials used are Al₂(SO₄)₃.14H₂O and ZrOCl₂.8H₂O. A hot-wall reactor having temperatures in the range 900-950° C. is used. Owing to the short residence times, it was only possible to obtain the phase formation of alpha-Al₂O₃ and tetragonal ZrO₂ in the sense of a composite after an additional calcination treatment at a temperature of 1200° C. and not directly a uniform mixed oxide which has reacted to give a uniform phase.

WO 0078672 A1 describes the use of a permeation and hot-gas reactor [lacuna] a spray pyrolysis process and the atomisation of metal-salt solutions or suspensions by means of an atomisation system comprising nozzle plate and piezoceramic oscillator.

WO 02072471 A1 describes a process for the preparation of multinary metal oxide powders for the use thereof as precursor for high-temperature supraconductors, where the corresponding metal oxide powders are prepared in a pulsation reactor and at least three elements selected from Cu. Bi, Pb, Y. Tl, Hg, La, lanthanides, alkaline-earth metals.

EP 0 371 211 describes a spray calcination for the preparation of ceramic powders by spraying solutions or suspensions into a flame pyrolysis reactor by means of a nozzle. For the spraying, a flammable gas (hydrogen) is used. This means that the fuel gas and the salt solutions reach the same point in the reactor via a two-component nozzle. The air necessary for the combustion flows in through a frit at the upper end of the reactor.

According to DE 195 05 133 A1, the hydrogen flame pyrolysis is carried out by feeding the salt solutions to the reactor with the oxygen gas as component of the reaction gas.

The description of Patent EP 703 188 B1 reveals that doped, amorphous and fully converted ZnO powders can be prepared by bringing the combination of an oxidising substance with a reducing substance to reaction in a temperature range between 220 and 260° C. In an exothermic reaction, the desired oxide is formed in powder form.

EP 1 142 830 A1 claims pyrolytically prepared oxidic nanopowders, such as, for example, ZrO₂, TiO₂ and Al₂O₃, which have a spec. surface area in the range 1-600 m²/g and a chloride content <0.05%.

According to JP10338520, yttrium aluminium oxide powders can be prepared by spray calcination of aqueous yttrium and aluminium salt solutions, preferably using polyaluminium chloride as a starting material.

WO2003/070640 A1 describes a process for the preparation of nanopowders based on Al₂O₃, SiO₂; TiO₂, ZrO₂ and additions of transition-metal oxides, lanthanides and actinides using a combination of metal alkoxides and carboxylates dissolved in oxidising solvents. During the pyrolysis, phase segregation into at least two different phases takes place.

DE 102 57 001 A1 claims az nanoscale (i.e. <0.1 μm), pyrogenically prepared Mg/Al spinel having a stoichiometric ratio of Mg to Al of 1:0.01 to 1:20 and a process for the preparation thereof. This is characterised in that salt solutions or dispersions are converted into MgAl₂O₄ in an (oxyhydrogen gas) flame at temperatures above 200° C. A particular feature of this invention is the aerosol generation by ultrasonic nebuliser or with the aid of a single-component nozzle which operates at high pressures (up to 10,000 bar, preferably up to 100 bar).

It is disadvantageous in this process that in general only low product through-puts can be achieved using ultrasonic nebulisers. Working at a pressure of up to 100 bar or even up to 10,000 bar is associated with very high technical complexity, meaning that this variant is unimportant per se for spray pyrolysis plants on an industrial scale.

The above-mentioned processes and the products produced by means of them furthermore contain the following disadvantageous features:

For the preparation of submicron or nanopowders, organometallic starting materials, mostly expensive, predominantly dissolved in organic solvents, are used.

The object of the present invention is therefore to overcome these disadvantages and to provide an inexpensive process which is simple to carry out by means of which mixed oxides can be prepared as compact, spherical particles having an average particle size of <10 μm. In particular, however, it is also an object of the present invention to provide mixed oxides which can serve for the preparation of high-density, high-strength, optionally transparent bulk material or as base material for phosphors or as phosphor or as starting material for ceramic production.

Flame spray pyrolysis does not usually enable non-porous, spherical, solid particles to be produced. This applies, in particular, on use of inexpensive chlorides and nitrates as starting materials (see FIG. 1).

Surprisingly, the present object can be achieved by on the one hand employing starting-material solutions of modified composition in a spray pyrolysis, and on the other hand spraying and pyrolysing the starting-material solutions in pyrolysis reactors with a specific temperature programme, with an additional fuel feed taking place during the pyrolysis reaction at a site which is located at a downstream site in the reactor, relative to the spray-in point.

In particular, this object is achieved through the use of preferably aqueous salt solutions, suspensions or dispersions in combination with additives by means of which the droplet size of the sprayed solutions, suspensions or dispersions is considerably reduced. Furthermore, the object according to the invention is achieved by a specific design of the spray pyrolysis process which is based on spraying the feed material into a stream of hot gas, preferably into the gas stream generated by flameless, pulsating combustion in a pulsation reactor in the form of an externally heated tubular reactor having a specific temperature profile (hot-wall reactor).

The process according to the invention differs considerably from the processes known from the prior art through the reactor construction, the process design, the energy transfer, the reaction course of the actual mixed-oxide formation.

It has been found that the above-mentioned disadvantages can be overcome by setting a certain ratio between the amount of air fed in and the amount of starting-material solution sprayed in during spraying-in by means of a two-component nozzle, and by simultaneously reducing the energy input at the spray-in point in combination with the introduction of additional fuel in the central part of the pyrolysis reactor and input of inherent chemical energy through substances having an exothermic chemical decomposition reaction and at the same time an oxidising action. The additional addition of surfactant, for example in the form of a fatty alcohol ethoxylate, effects the formation of finer particles having an even more uniform spherical shape.

It can be shown with reference to the example of powders based on Mg and Y aluminates and Ba titanate that finely disperse, spherical powders having an average particle size in the range 0.01-2 μm can be prepared by means of a combination of the inventive measures (see, for example, FIGS. 2 to 6). Pores are not evident here on the particles in the SEM picture with a magnification of up to 20,000 times (see FIGS. 4 and 6), in contrast to the powders of FIG. 1 which are not in accordance with the invention.

The starting materials used here were mixed nitrate solutions which comprise the corresponding elements in the requisite stoichiometric ratio. As chemical energy carrier, ammonium nitrate was added to these solutions in a proportion of 10-50%, preferably 20-40%, based on the salt content of the starting solution. The particle size can be reduced further by means of dilution, preferably by 50%.

In accordance with the invention, it is necessary to reduce the energy input at the spray-in point in order to prevent rapid crust formation on the particles forming during the evaporation of the solvent. At industrially relevant feed throughputs, the short residence times in the pyrolysis reactors mean that initially complete conversion into the mixed oxides does not take place in every case, and the powders contain a calcination loss of greater than 5%.

In particular on use of a reactor with hot-gas generation by pulsating, flameless combustion in the form of a ramjet tube (pulsation reactor), the introduction of an additional amount of fuel gas (natural gas or hydrogen) enables the energy input to be increased at the time at which solvent is no longer present in the interior of the particles. This energy serves to thermally decompose salt residues still present and to accelerate or complete the solid-state chemical processes of mixed-oxide formation. The feed of the reaction gas takes place in accordance with the invention after 20-40%, preferably 30%, of the total residence time of the substances in the reactor.

Surprisingly, it has been found that complete conversion of an Mg/Al mixed nitrate solution into MgAl₂O₄ can be achieved in a laboratory reactor of small size and short product residence times of about 200-500 milliseconds. The morphology of the particles produced in this way is spherical, and the average particle size is 1.8 μm. (See FIG. 7). The calcination loss here, due to adduction of OH groups on the powder surface, is about 2%. This is not disadvantageous for further processing to give a ceramic material since the powder is very readily dispersible in water as it has zeta potentials above 100 mV (4<pH<6).

For this reason, it is also possible to prepare submicron powders in the sense of an inexpensive top-down process by dispersal in water and subsequent comminution in annular-gap or stirred ball mills (see particle size distribution of FIG. 8). On the other hand, this is also achieved by separating off the coarse particles by classification or comminution in fluidised-bed counterjet mills (see particle size distribution of FIG. 9).

It has proven particularly surprising that spinel formation by means of spray pyrolysis in short-time reactors, such as, for example, in laboratory reactors, can be achieved not only by dissolution, but instead also by dispersal of salts or hydroxides, such as, for example, Mg(OH)₂, in aluminium nitrate solution, to be precise without X-ray detection of residual single oxides (see FIG. 10). This considerably increases the metal content of the starting material and the product discharge, but results in higher average particle sizes of about 6 μm. This particle size can surprisingly be reduced again by addition of ammonium nitrate and fatty alcohol ethoxylate and if necessary by dilution of the starting solution. Depending on the water content of the Al nitrate solution, the Mg(OH)₂ is soluble or flocculates out in finely disperse form on further dilution. In both cases, homogeneous, finely disperse spinel powder is produced. In a pilot-plant reactor with correspondingly increased product residence time in the order of 500-1000 milliseconds, greater throughputs can be achieved in this way, with products having similar powder features being produced (see particle size distribution of FIG. 11).

A further starting-material variant according to the invention is an aqueous magnesium acetate solution with AlO(OH) dispersed therein as Al component (see Example 7), producing extremely fine powder, which is completely converted as far as the spinel in the pulsation reactor.

Submicron powders are also prepared in accordance with the invention by spray pyrolysis of a solution of Al triisopropoxide in petroleum ether with sub-sequent dispersal of finely particulate Mg ethoxide. The high inherent chemical energy in the spray pyrolysis process results in the formation of particles in the range 100-200 nm (see FIG. 12). The temperature is limited at the spray-in point by the arrangement of an upstream, pulsating hot-gas generator, the spraying-in of starting material and simultaneous introduction of cold air into the combustion chamber and the supply of fuel in the resonance tube.

The starting-material combination in the form of Ba acetate and tetraisopropyl titanate also results in spherical Ba titanate powders in the submicron range (see Example 9).

In the Y—Al—O system, the phase formation is influenced to a particularly great extent by the nature of the starting materials and the thermal decomposition thereof.

According to J. of Alloys and Compounds 255 (1997), pp. 102-105, it is difficult, in particular by means of solid-state reaction processes, to prepare phase-pure, cubic Y₃Al₅O₁₂ (YAG). Even at calcination temperatures of 1600° C., the oxides of Al and Y and the YAlO₃ (perovskite phase: YAP) and Y₄Al₂O₉ (monoclinic phase: YAM) phases are prepared besides the cubic YAG phase.

In the process according to the invention, the nitrates of yttrium and aluminium, inter alia, are used as starting materials for the spray pyrolysis. In this case, the Y₃Al₅O₁₂ phase corresponding to the chemical starting composition initially does not yet form, but instead partially amorphous aluminium oxide and a phase mixture of yttrium aluminates in the form of about 90% of YAlO₃ and about 10% of Y₃Al₅O₁₂. Thermal post-treatment in the temperature range from 900° C. to 1200° C., preferably 1100° C., enables the material to be converted completely into the cubic YAG phase (see FIG. 13). This is necessary, in particular, for use as phosphor.

However, it has been found that the partially reacted, uncalcined powder has higher reactivity in the preparation of densely sintered bulk material. Thus, on hot pressing of this powder for 30 min at 1600° C., a higher density (99.98% of the theoretical density compared with 98.7% on use of the pre-calcined powder) was achieved. After a calcination process at 1200° C. in order to remove the carbon, this material exhibited translucence, it being possible for a trans-parent material to be formed with further optimisation in order to minimise the crystallite size and residual porosity.

A particularly narrow particle size distribution can be achieved with the starting-material choice in the form of Y chloride solution mixed with an aluminium nitrate solution in the pre-specified mixing ratio corresponding to the later stoichiometry (see FIG. 14). Amorphous powder contents of about 80% form here in a hot-wall reactor with very short product residence time. Besides the target phase Y₃Al₅O₁₂, the crystalline phases are the YAlO₃ phase in approximately the same proportion and highly reactive transition metal/aluminium oxides (kappa and theta phase) and yttrium oxide. This phase mixture can be converted into the YAG phase by calcination at about 1000° C.

The features described for the preparation of Mg aluminate powder, that the particle morphology, size and size distribution can be influenced in a targeted manner by the combination of additives in the form of water, ammonium nitrate and surfactant and control of the temperature conditions in the reactor, also apply to the yttrium aluminates. Round solid particles having a size of up to about 2 μm are evident in the powder prepared in accordance with the invention.

The particle size is influenced independently of the spray conditions by the preparation and spray pyrolysis of emulsions.

In the process described in DE 4307 333, the material to be sprayed is introduced into an externally electrically heated tubular reactor or preferably directly into the region of the flame generated by means of combustion of a flammable gas, such as propane, butane or natural gas and (atmospheric) oxygen. A combined arrangement of gas burner and injection nozzle is mentioned therein as being particularly advantageous, the injection nozzle preferably being arranged centrally in the burner head. It is stated that this ensures maximum contact of the sprayed emulsion droplets with the burner flame.

The process described in the literature [Journal of the Korean Ceramic Soc. 27 (1990), No. 8; pp. 955-964] is likewise an electrically heated tubular reactor.

By contrast, the emulsion with the process according to the invention is sprayed into the stream of hot gas generated by means of pulsating, flameless combustion of natural gas or hydrogen with air, the temperature in the central reactor part being limited to about 1030° C.

The emulsion is prepared, for example, by intensive mixing of the salt solution and the dispersion medium and the emulsifier in a high-pressure homogeniser of the Niro Soavi design.

Emulsifiers which can be used here are sorbitan fatty acid derivatives or particularly advantageously a mixture thereof with a random copolymer containing hydrophobic and hydrophilic side chains in a ratio of 4:1 to 2:3; preferably a random copolymer consisting of dodecyl methacrylate and hydroxyethyl methacrylate in the ratio 1:1 to 3:1, as described in European Patent Application No. 04023002.1 of Merck Patent GmbH, filed on Sep. 28, 2004.

Corresponding copolymers can be described by the general of the formula I

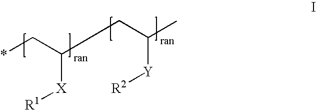

in which the radicals X and Y correspond to conventional nonionic or ionic monomers and
R¹ denote hydrogen or a hydrophobic side group, preferably selected from the branched or unbranched alkyl radicals having at least 4 carbon atoms, in which one or more, preferably all, H atoms may be replaced by fluorine atoms, and, independently of R¹,
R² stands for a hydrophilic side group, which preferably has a phosphonate, sulfonate, polyol or polyether radical.

Particular preference is given in accordance with the invention to polymers in which —Y—R² stands for a betaine structure.

In this connection, particular preference is in turn given to copolymers of the formula I in which X and Y, independently of one another, stand for —O—, —C(═O)—O—, —C(═O)—NH—, —(CH₂)ₙ—, phenyl, naphthyl or pyridiyl. Furthermore, copolymers in which at least one structural unit contains at least one quaternary nitrogen atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻ side group, where m denotes an integer from the range 1 to 30, preferably from the range 1 to 6, particularly preferably 2, and n stands for an integer from the range 1 to 30, preferably from the range 1 to 8, particularly preferably 3, have particularly advantageous properties in the use according to the invention.

On use of an emulsifier mixture of this type, the emulsion has improved stability (no separation within 12 hours). This results in simplification of the technological process, in improvement in the powder morphology (see FIG. 15) and in an increase in the reproducibility of the powder properties.

The introduction of combustible substances with the emulsion, such as petroleum ether, into the reactor must be correspondingly compensated by reduction of the feed of fuel gas to the reactor in order that hard agglomerates do not form. By setting a reference temperature of 1000 to 1050° C. in the resonance tube of the pulsation reactor, this is ensured and nevertheless complete spinel formation is achieved.

The powders having the different particle sizes and particle size distributions prepared with the compositions described above can be processed further and used in various ways.

For the preparation of high-density, finely crystalline, optionally transparent ceramics at relatively low sintering temperatures, finely disperse powders offer considerable advantages, where powders having a particle size of about 100 nm can be used for the hot-pressing technology. These powders usually cannot be processed or can only be processed with increased technical complexity during shaping with other ceramic processes. For these processes, the use of powders in the submicron range is advisable.

Should specific properties, such as high mechanical strengths and/or optical transparency, be achieved, powders having average particle sizes of 0.3-0.6 μm and narrow particle size distributions, for example characterised by d₉₉ values of the particle-size volume distribution in the range from 1 to 3 μm, can then advantageously be used (see FIGS. 8 and 9).

Magnesium or yttrium aluminates doped with rare-earth elements (RE), such as, for example, Ce, Pr, Nd, Sm, Eu, Gd, Tb, Dy, Er, Tm, Yb and mixtures thereof, are used in accordance with the prior art as phosphor material, where the above-mentioned RE metals are effective as activator elements [Angew. Chem. 110 (1998); pp. 3250-3272]. Examples which may be mentioned are, inter alia:

Y₃Al₅O₁₂:Ce; (Y₁₋ₓGdₓ)₃ (Al_{1-y}Ga_{y})₅O₁₂:Ce; Y₃(Al,Ga)₅O₁₂:Tb; BaMgAl₁₀O₁₇:Eu; BaMgAl₁₀O₁₇:Eu,Mn; (Ce,Tb)MgAl₁₁O₁₉:Eu; Sr₄Al₁₄O₂₅:Eu; SrAl₁₂O₁₉:Ce.

The specialist literature accessible to the person skilled in the art (Römpp's Chemie Lexikon [Römpp's Lexicon of Chemistry]—Version 1.0, Stuttgart/New York: Georg Thieme Verlag 1995; Ullmann's Encyclopedia of Industrial Chemistry, 2002; Wiley-VCH Verlag GmbH & Co. KGaA.; Article Online Posting Date Jun. 15, 2000) discloses that the preparation of phosphors on an industrial scale is carried out in electrically or gas-heated combustion furnaces, depending on the nature of the base materials, at temperatures between about 700° and 1600°. In particular in solid-state reaction processes without addition of fluxing agents and subsequent calcination at relatively high temperatures of up to 1600° C., this generally does not result in compact, spherical particles which would be advantageous for such applications. Examples thereof are:

cerium magnesium aluminates, such as, for example, Ce_{0.65}Tb_{0.35}MgAl₁₁O₁₉, prepared by co-precipitation of metal hydroxides from nitrate solutions using NH₄OH and subsequent calcination at 700 C for 2 h and subsequently at 1500° C. for 1 h.

Barium magnesium aluminates, such as, for example, BaMg₂Al₁₆O₂₇:Eu²⁺, prepared by mixing Al₂O₃, BaCO₃, MgCO₃, and Eu₂O₃ in the presence of a fluxing agent and a weakly reducing atmosphere at 1100 to 1200° C.

The process according to the invention is not suitable just for the production of spherical particles of different particle size. It is also possible to prepare sub-stance systems of this type in a corresponding manner since a multiplicity of different dopings, also in a small amount, can be introduced and distributed homogeneously starting from the mixing and spraying of salt solutions. Even if a subsequent calcination process is necessary in order to establish a certain phase composition, the temperature to be set for this purpose can be selected lower and the powder morphology and the homogeneity are retained as far as the end product.

From a comparison of an undoped and a Ce-doped Y₃Al₅O₁₂ material, it may be noted that even with the doping (see Example 12), powder present after the spray pyrolysis is converted completely into the cubic crystal phase by subsequent thermal treatment at 1200° C.

Owing to their spherical morphology and the greater packing density that can thus be achieved compared with other geometrical shapes, these powders can advantageously be used as phosphor base material. These can then particularly advantageously be employed for the production of white-light-emitting illumination systems by combination of a blue emitter with the above-mentioned phosphors, for example for inorganic and organic light-emitting diodes.

The variability of the powders which can be prepared in accordance with the invention also facilitates the simple and inexpensive production of abrasion- and scratch-resistant layers, which may also be transparent and can be produced by the methods of plasma spraying, flame spraying, spin coating, dip coating, optionally with subsequent thermal treatment, which are conventional in the art.

### EXAMPLES

For better understanding and in order to illustrate the invention, examples are given below which, with the exception of Example 1, are within the scope of protection of the present invention. These examples also serve to illustrate possible variants. Owing to the general validity of the inventive principle described, however, the examples are not suitable for reducing the scope of protection of the present application to these alone.

The temperatures given in the examples are always in ° C. It furthermore goes without saying that, both in the description and also in the examples, the added amounts of the components in the compositions always add up to a total of 100%. Percentages given should always be regarded in the given connection. However, they usually always relate to the weight of the part or total amount indicated.

### Example 1

### Comparative Example, not According to the Invention

Magnesium nitrate hexahydrate (analytical grade from Merck KGaA) and aluminium nitrate nonahydrate (analytical grade from Merck KGaA) are each dissolved separately in ultrapure water so that the solutions have a metal content of 6.365% of Mg and 4.70% of Al respectively. The metal contents are determined with the aid of complexometric titration. An Mg/Al mixed nitrate solution which contains the elements Mg and Al in the molar ratio 1:2 is then prepared by vigorous stirring.

This solution is sprayed at a feed rate of 2 kg/h into a flame generated by combustion of hydrogen and air (hydrogen flame pyrolysis reactor). The flame temperature here is >1000° C., the reactor temperature at the reference point (reactor end at which the reaction gases exit from the reaction chamber) is 700° C. The powder output is 0.2 kg/h.

### Powder Properties:

calcination loss: 0.86%
particle size distribution: d₅₀=4.7 μm, d₉₅=15.2 μm, d_{99.9}=38 μm
particle morphology: irregularly shaped, many pores (see FIG. 1)
specific surface area (BET): 38 m²/g
phases (X-ray diffractometry): spinel (MgAl₂O₄) well crystallised.

### Example 2

### According to the Invention

Magnesium nitrate hexahydrate (analytical grade from Merck KGaA) and aluminium nitrate nonahydrate (analytical grade from Merck KGaA) are each dissolved separately in ultrapure water so that the solutions have a metal content of 6.365% of Mg and 4.70% of Al respectively. The metal contents are determined with the aid of complexometric titration. An Mg/Al mixed nitrate solution which contains the elements Mg and Al in the molar ratio 1:2 is then pre-pared by vigorous stirring. The solution is diluted with ultrapure ratio in the ratio 1:1.

A further addition of ammonium nitrate (analytical grade from Merck KGaA) in an amount of 35%, based on the nitrate salt content, and of a fatty alcohol ethoxylate (Lutensol AO3 from BASF AG) in an amount of 10%, based on the weight of the entire solution, is then carried out.

After stirring for 2 hours, this mixture is introduced at a feed rate of 10 kg/h by means of a two-component nozzle (feed:air ratio=0.5) into the stream of hot gas, generated by flameless combustion of natural gas and air, of the combustion chamber of a pulsation reactor (pilot-plant scale). The combustion chamber temperature is 726° C. After the stream of hot gas with the newly formed solid particles and the reaction gases has flowed through the combustion chamber, it is re-warmed to 1027° C. in the resonance tube by the supply of further fuel in the form of hydrogen.

Before entering the filter, the gas/particle stream is cooled to about 160° C. by supply of ambient air. This enables inexpensive cartridge filters to be used instead of hot-gas filters for separating off the powder particles from the gas stream.

The basic structure of the pulsation reactor including the temperature progression is depicted in FIG. 16.

### Further Reactor Parameters:

ratio of the amount of combustion air to the amount of fuel (natural gas): 26:1
ratio of the amount of added fuel (H2) to the amount of fuel (natural gas): 4.25:1
ratio of air to feed material (solution) at the two-component nozzle: 2.35:1.

### Powder Properties:

calcination loss: 1.6%
particle size distribution: d₅₀=1.8 μm, d₉₅=3.4 μm, d_{99.9}=6 μm (see FIG. 7)
particle morphology: spherical particles (see FIG. 2)
specific surface area (BET): 25 m²/g
phases (X-ray diffractometry): spinel (MgAl₂O₄) well crystallised.

### Example 3

### According to the Invention

Yttrium nitrate hexahydrate (Merck KGaA) and aluminium nitrate nonahydrate (analytical grade from Merck KGaA) are each dissolved separately in ultrapure water so that the solutions have a metal content of 15.4% of Y and 4.7% of Al respectively. The metal contents are determined with the aid of complexometric titration. A Y/Al mixed nitrate solution in which the elements Y and Al are present in the molar ratio 3:5 is then prepared by vigorous stirring. The solution is diluted with ultrapure water in the ratio 1:1.

A further addition of ammonium nitrate (analytical grade from Merck KGaA) in an amount of 35%, based on the nitrate salt content, and of a fatty alcohol ethoxylate (Lutensol AO3 from BASF) in an amount of 10%, based on the weight of the entire solution, is carried out.

After stirring for 2 hours, this mixture is introduced at a feed rate of 10 kg/h by means of a two-component nozzle (feed:air ratio=0.5) into the stream of hot gas, generated by flameless combustion of natural gas and air, of the combustion chamber of a pulsation reactor (pilot-plant scale). The combustion-chamber temperature is 695° C. After the stream of hot gas with the newly formed solid particles and the reaction gases has flowed through the combustion chamber, it is re-heated to 1025° C. in the resonance tube by the supply of further fuel in the form of hydrogen.

### Further Reactor Parameters:

ratio of the amount of combustion air to the amount of fuel (natural gas): 26:1
ratio of the amount of added fuel (H2) to the amount of fuel (natural gas): 4.25:1
ratio of air to feed material (solution) at the two-component nozzle: 2.35:1.

### Powder Properties:

calcination loss: 0.5%
particle size distribution: d₅₀=1.4 μm, d₉₅=3 μm, d_{99.9}=5 μm
particle morphology: spherical particles (see FIGS. 5 and 6)
specific surface area (BET): 7 m²/g
phases (X-ray diffractometry): crystalline fractions in the form of 11% of Y₃Al₅O₁₂ (YAG) and 89% of YAlO₃ (YAP)

### After Calcination for 4 h at 1200° C. in Air:

specific surface area (BET): 5 m²/g
phases (X-ray diffractometry): 100% of Y₃Al₅O₁₂ (YAG)

### Example 4

### According to the Invention

Preparation of the solutions and spray pyrolysis in the pulsation reactor in accordance with Example 2.

The powder discharged from the reactor is dispersed in deionised water so that the solids content is 30% by weight. The dispersion is ground for 200 min in an annular-gap ball mill of the “Coball Mill” type from Fryma using 1 mm Al₂O₃ balls with the following parameters:
rotor speed—1900 rpm; corresponds to a peripheral velocity of 13 m/s
throughput—40 kg/h
pH—8
total energy input—4.7 kWh.

The suspension is subsequently dried in a Niro Minor laboratory spray dryer.

### Powder Properties:

calcination loss: 1.6%
particle size distribution: d₅₀=0.4 μm, d₉₅=2.8 μm, d_{99.9}=4 μm (see FIG. 8).
particle morphology: spherical particles
specific surface area (BET): 35 m²/g
phases (X-ray diffractometry): spinel (MgAl₂O₄).

### Example 5

### According to the Invention

Preparation of the Y nitrate and Al nitrate solutions and spray pyrolysis in the pulsation reactor are carried out as described in Example 3.

For the most complete formation of the YAG phase possible, the powder pre-pared is calcined in a chamber furnace at 1130° C. for 4 h and then comprises 98.5% of cubic Y₃Al₅O₁₂ (YAG) and 1.5% of hexagonal YAl₁₂O₁₉. The coarse particles are then separated off using the 100 MZR centripetal classifier with a classifier wheel speed of 19,000 rpm, an air throughput of 15 m³/h and a product throughput of 0.4 kg/h.

### Powder Properties:

calcination loss: 0.5%
particle size distribution: d₅₀=0.48 μm, d₉₅=1.7 μm, d_{99.9}=3 μm (see FIG. 9).
particle morphology: spherical particles
specific surface area (BET): 21 m²/g

### Example 6

### According to the Invention

0.06 kg of Mg(OH)₂ of the Magnifin-H10 type from Magnesia-Produkte GmbH are dispersed in 1.2 kg of aluminium nitrate solution having a metal content of 4.5%, 0.254 kg of ammonium nitrate are added, and the mixture is sprayed into the laboratory reactor and pyrolysed, with the temperature profile being set analogously to Example 2.

### Reactor Parameters:

temperature of combustion chamber: 800° C.
temperature of resonance tube: 1080° C.
ratio of the amount of combustion air to the amount of fuel (natural gas): 40:1
feed:air factor at the two-component nozzle: 0.4.

### Powder Properties:

calcination loss: 2.0%
particle size distribution: d₅₀=3.2 μm, d₉₅=8.6 μm, d_{9.99}=15 μm
particle morphology: spherical particles
specific surface area (BET): 18 m²/g
phases (X-ray diffractometry): spinel (MgAl₂O₄) without detection of residual single oxides (see FIG. 10).

The spraying of this suspension, which is again diluted in the ratio 1:1 with ultrapure water, in a pilot-plant reactor as described in Example 2 leads to the following

### Powder Properties:

calcination loss: 1.2%
particle size distribution: d₅₀=2.1 μm, d₉₅=4.4 μm, d_{99.9}=6 μm (see FIG. 11).
particle morphology: spherical particles
specific surface area (BET): 26 m²/g
phases (X-ray diffractometry): spinel (MgAl₂O₄)

### Example 7

### According to the Invention

AlO(OH) as Al component is dispersed in a magnesium acetate solution (aqueous) with the following sample weight:
2.145 kg of Mg acetate.4H₂O dissolved in 2.95 kg of water
1.20 kg of AlO(OH) of the Martoxal BN-2A type from Abemarle Corp.

The suspension is sprayed into the laboratory reactor by means of a two-component nozzle and pyrolysed, with the temperature profile being set analogously to Example 2.

### Reactor Parameters:

temperature of combustion chamber: 780° C.
temperature of resonance tube: 1054° C.
ratio of the amount of combustion air to the amount of fuel (natural gas): 40:1
feed:air factor at the two-component nozzle: 0.4.

### Powder Properties:

calcination loss: 3.1%
particle size distribution: d₅₀=2.1 μm, d₉₅=4.3 μm, d_{99.9}=8 μm
particle morphology: spherical particles
specific surface area (BET): 30 m²/g
phases (X-ray diffractometry): crystalline fractions of spinel (MgAl₂O₄) and oxides of Mg and Al

On processing in the pilot-plant reactor with the reaction parameters in accordance with Example 2, complete conversion into spinel occurs.

### Example 8

### According to the Invention

Al triisopropoxide is dissolved in petroleum ether (petroleum benzine of boiling range 100-140° C. from Merck KGaA), with subsequent dispersion of finely particulate Mg ethoxide so that Mg and Al are present in the molar ratio 1:2. This is followed by spray pyrolysis in a laboratory pulsation reactor under the following conditions:

### Reactor Parameters:

temperature of combustion chamber: 795° C.
temperature of resonance tube: 954° C.
ratio of the amount of combustion air to the amount of fuel (natural gas): 41:1
feed:air factor at the two-component nozzle: 0.4.

In order to set the temperature profile, i.e. reduced temperature at the spray-in point and subsequent temperature increase in the resonance tube, a hot-gas generator is used upstream of the combustion chamber. The above-mentioned temperatures are set by feeding cooling air into the combustion chamber and supplying energy to the resonance tube.

In this case, the additional input of energy through petroleum ether means that there is only a slight additional feed of fuel gas.

### Powder Properties:

calcination loss: 3.5%
particle size in the range 100-200 nm (according to SEM; see FIG. 12)
particle morphology: spherical particles
specific surface area (BET): 55 m²/g
phases (X-ray diffractometry): spinel (MgAl₂O₄)

### Example 9

### According to the Invention

194.59 g of barium acetate are stirred into 500 ml of isopropanol. A white suspension forms (mixture 1).

Separately, a mixture of 217.61 g of tetraisopropyl orthotitanate and 500 ml of isopropanol is prepared (mixture 2).

Mixture 1 and mixture 2 are combined with stirring.

This suspension is sprayed in the laboratory reactor at 800° C. in the combustion chamber and pyrolysed as described in Example 8.

### Powder Properties:

particle size distribution: d50=150 nm, d95=220 nm, d99.9=1 μm
particle morphology: spherical particles
specific surface area (BET: 15 m²/g)
phases (X-ray diffractometry): BaTiO₃ (tetragonal), residues of TiO₂ (rutile)

### Example 10

### According to the Invention

An Mg/Al mixed nitrate solution is prepared as described in Example 2. Emulsifier in the form of a random copolymer consisting of dodecyl methacrylate and hydroxyethyl methacrylate in the ratio 2:1 having a molecular weight of 5000 g/mol is then dissolved in petroleum ether (petroleum benzine of boiling range 100 to 140° C. from Merck KGaA), giving a 35% solution. This solution is mixed with the Mg/Al mixed nitrate solution in the ratio 2:1 by means of a stirrer. By pumped circulation by means of a Niro/Soavi-type high-pressure homogeniser for about 0.5 h, the mixture formed in this way is converted into an emulsion in which the salt solution are dispersed as preformed droplets in petroleum ether. The spray pyrolysis is then carried out in a pulsation reactor (pilot-plant scale) with the following conditions:

### Reactor Parameters:

temperature of combustion chamber: 1023° C.
temperature of resonance tube: 1026° C.
ratio of the amount of combustion air to the amount of fuel (natural gas): 36:1
ratio of air to feed material at the two-component nozzle: 5.7:1.

In this case, the additional input of energy through petroleum ether means that there is no additional supply of fuel gas.

### Powder Properties:

calcination loss: 4.5%
particle size distribution: d₅₀=0.8 μm, d₉₅=1.5 μm, d_{99.9}=2.5 μm
particle morphology: spherical particles
specific surface area (BET): 28 m²/g
phases (X-ray diffractometry): spinel (MgAl₂O₄)

### Example 11

### According to the Invention

Yttrium nitrate hexahydrate (Merck KGaA), aluminium nitrate nonahydrate (analytical grade from Merck KGaA) and cerium nitrate hexahydrate (“extra-pure” grade from Merck KGaA) are each dissolved separately in ultrapure water so that the solutions have a metal content of 15.4% by weight of Y, 4.7% by weight of Al and 25.2% by weight of Ce. This is followed by the preparation of a Y/Al/Ce mixed nitrate solution which contains the elements Y, Al and Ce in the molar ratio 2.91:5:0.09. The solution is diluted with ultrapure water in the ratio 1:1, and ammonium nitrate (analytical grade from Merck KGaA) is then furthermore added in an amount of 35%, based on the nitrate salt content

This mixture is sprayed into a laboratory reactor by means of a two-component nozzle, with the temperature profile being set analogously to Example 2. The particles are separated off from the stream of hot gas by means of a hot-gas filter.

### Reactor Parameters:

temperature of combustion chamber: 760° C.
temperature of resonance tube: 1075° C.
ratio of the amount of combustion air to the amount of fuel (natural gas): 42:1
feed:air factor at the two-component nozzle: 0.4.

### Powder Properties:

calcination loss: 0.5%
particle size distribution: d₅₀=1.9 μm, d₉₅=4.1 μm, d_{99.9}=7 μm
particle morphology: spherical particles
specific surface area (BET): 6.9 m²/g
phases (X-ray diffractometry): crystalline fractions in the form of Y₃Al₅O₁₂, YAlO₃, Y₂O₃ and amorphous fractions, presumably in the form of oxides

### After Calcination at 1200° C. in Air for 4 h:

specific surface area (BET): 4.5 m²/g
phases (X-ray diffractometry): 100% cubic mixed crystal phase.

1. Process for the preparation of mixed oxide powders comprising compact, spherical particles having an average particle size of <10 μm by spray pyrolysis by bringing the starting materials in the form of salts, oxides, hydroxides, organometallic compounds, individually or as a mixture, into solution, suspension or dispersion and spraying these into a stream of hot gas generated by pulsating, flameless combustion of natural gas/air mixtures or hydrogen/air mixtures into a reactor, pyrolysing them and converting them into mixed oxides or precursors thereof, characterised in that either the temperature at the spray-in point is limited to 600-1000° C., preferably 700-800° C., and, in order to accelerate the mixed oxide formation, fuel is additionally supplied to the pyrolysis reactor at a site which is at a down-stream site after the spray-in point, relative to the stream of hot gas, or in order to control the particle size, a solution, suspension or dispersion in the form of a water/oil emulsion is sprayed and pyrolysed.

2. Process according to claim 1, characterised in that the addition of additional fuel in the form of natural gas or hydrogen takes place after a residence time of the substances in the reactor of 20-40%, preferably 30%, of the total residence time.

3. Process according to claim 1, characterised in that the starting materials used are nitrates, chlorides, hydroxides, acetates, ethoxides, butoxides or isopropoxides, or mixtures thereof.

4. Process according to claim 1, characterised in that the starting materials used are salts, hydroxides or organometallic compounds of elements from groups IIA (IUPAC: 2), IIIA (13), IIIB (3) and IVB (4) VIB and VIIB.

5. Process according to claim 1, characterised in that the starting materials used are salts, oxides, hydroxides or organometallic compounds of Al and/or Ti of elements from groups IIA and IIIB.

6. Process according to claim 1, characterised in that an inorganic substance which generates additional thermal energy due to its exothermic decomposition and simultaneously has an oxidising action is added to the solution, dispersion or suspension to be sprayed.

7. Process according to claim 6, characterised in that the additionally added substance is a nitrate, preferably an ammonium nitrate, and in that the amount added is 10 to 80%, preferably 25-50%, based on the amount of starting material employed.

8. Process according to claim 1, characterised in that a surfactant is added to the solution, dispersion or suspension to be sprayed.

9. Process according to claim 8, characterised in that the surfactant used is a fatty alcohol ethoxylate in an amount of 1-10% by weight, preferably 3-6%, based on the total amount of the solution.

10. Process according to claim 1, characterised in that, for the preparation of a water/oil emulsion, a mixture of nitrates and/or chlorides dissolved in water is introduced into a hydrocarbon, dispersed to give droplets by means of mechanical shear forces and stabilised by addition of an assistant.

11. Process according to claim 10, characterised in that a petroleum benzine having a boiling range of 80-180° C., preferably 100-140° C., is used in combination with emulsifiers which are soluble therein and have an HLB (hydrophilic-lipophilic balance) value in the range 2-8.

12. Process according to claim 10, characterised in that the emulsifiers used are sorbitan fatty acid derivatives and mixtures thereof having a different HLB value.

13. Process according to claim 10, characterised in that the emulsifiers used is a mixture of fatty acid sorbitan esters and a random copolymer containing at least one monomer having a hydrophilic side chain and at least one monomer having a hydrophobic side chain and a molecular weight between 1000 and 50,000, preferably between 2000 and 20,000.

14. Process according to claim 13, where the random copolymer used are copolymers of the general of the formula I 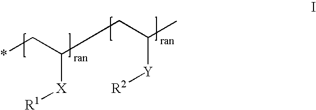
in which the radicals X and Y correspond to conventional nonionic or ionic monomers and R¹ denotes hydrogen or a hydrophobic side group selected from the branched or unbranched alkyl radicals having at least 4 carbon atoms, in which one or more, H atoms may be replaced by fluorine atoms, and, independently of R¹,
R² stands for a hydrophilic side group which has a phosphonate, sulfonate, polyol or polyether radical.

15. Mixed oxide powder based on aluminates and titanates, prepared according to claim 1, characterised in that the average particle size thereof is in the range 1-5 μm, has a specific surface area (by the BET method) in the range 3-30 m²/g, preferably 5-15 m²/g, and has a compact, spherical morphology.

16. Mixed oxide powder based on aluminates and titanates, prepared according to claim 1, characterised in that the average particle size thereof is in the range 0.1-1 μm, has a specific surface area (by the BET method) in the range 10-60 m²/g, preferably 20-40 m²/g, and has a compact, spherical morphology.

17. Use of a mixed oxide powder according to claim 15, for the preparation of high-density, high-strength, optionally transparent bulk material.

18. Mixed oxide powder based on aluminates and titanates, prepared according to claim 1, characterised in that the average particle size thereof is in the range 0.01-0.2 μm, has a specific surface area (by the BET method) in the range 20-100 m²/g, preferably 40-80 m²/g, and has a spherical morphology.

19. Use of a mixed oxide powder according to claim 18 for the preparation of high-density, high-strength and optionally transparent bulk material by means of hot-pressing technology.

20. Use of a mixed oxide powder according to claim 15 as base material for phosphors or as phosphor or as starting material for ceramic production.

21. A method of preparing high-density, high-strength and optionally transparent bulk material comprising hot pressing a mixed oxide powder of claim 18.
